(19) United States
(12) Patent Application Publication
(10) Pub. No.: US 2021/0284033 A1
(43) Pub. Date: Sep. 16, 2021

(54) NON-CONTACT CHARGING SYSTEM

(71) Applicant: Honda Motor Co., Ltd., Tokyo (JP)

(72) Inventor: Takuya IWAMOTO, Saitama (JP)

(73) Assignee: Honda Motor Co., Ltd., Tokyo (JP)

(21) Appl. No.: 17/195,549

(22) Filed: Mar. 8, 2021

(30) Foreign Application Priority Data
Mar. 11, 2020 (JP) 2020-042095

(51) Int. Cl. B60L 53/124; B60L 53/62; B60L 53/66

(52) U.S. Cl. CPC B60L 53/124; B60L 2250/16; B60L 53/66; B60L 53/62

(57) ABSTRACT

Corresponding to a case in which the existence and the type of foreign matter that obstructs power transmission around a power transmission unit are detected when a battery mounted on a vehicle is charged by a non-contact method, a power transmission amount of the power transmission unit is reduced, and the reduction amount is controlled according to a difference in the type of the foreign matter. A notification for urging the removal of the foreign matter is intentionally omitted when it is predicted that the charging of the battery mounted on the vehicle is completed before a use start time of the vehicle or before a predetermined period elapses from the use start time of the vehicle even if the power transmission amount of the power transmission unit is reduced.

### CROSS-REFERENCE TO RELATED APPLICATION

This application claims the priority benefits of Japanese application no. 2020-042095, filed on Mar. 11, 2020. The entirety of the above-mentioned patent application is hereby incorporated by reference herein and made a part of this specification.

### BACKGROUND

### Technical Field

The disclosure relates to a system which charges an in-vehicle battery by a non-contact method.

### Related Art

In a non-contact power supply system, a technical method is proposed in which if a living body is detected, supply power is limited, and if a time during which the supply power is limited (calculated by a difference between a present SOC and a SOC in which charging is completed) is longer than a set time, the outside is informed (for example, see Japanese Patent No. 5218576).

In a wireless power transmission system, a technical method is proposed in which when it is detected that a person approaches a vehicle, transmission power from a power transmission section to a power reception section is suppressed (for example, see Japanese Patent Laid-Open No. 2012-005226).

However, if the charging is stopped unconditionally every time foreign matter or a living body is detected around a vehicle, a charging completion timing of a battery mounted on the vehicle may unnecessarily become late. In addition, if a user is urged to remove the foreign matter or the living body every time the charging is stopped, the user may feel annoyed.

Therefore, the disclosure aims to provide a system which can shorten a required charging period of a battery mounted on a vehicle even in a case in which the existence of foreign matter is detected when the battery is charged by a non-contact method.

### SUMMARY

A non-contact charging system of the disclosure includes:
a power transmission unit, which transmits power to a power reception unit mounted on a vehicle by a non-contact method in order to charge a battery mounted on the vehicle;
a charging control device, which controls a power transmission amount of the power transmission unit; and
a foreign matter detection section, which is used for detecting the existence and the type of foreign matter that exists around the power transmission unit; wherein
based on a requirement that the existence and the type of the foreign matter are detected by the foreign matter detection section when the power is transmitted to the power reception unit by the power transmission unit, the charging control device reduces the power transmission amount of the power transmission unit, and changes the reduction amount of the power transmission amount of the power transmission unit according to a difference in the type of the foreign matter.

In the non-contact charging system, preferably, the charging control device includes:
a battery residual capacity recognition section, which recognizes a residual capacity of the battery;
a power transmission amount detection section, which detects a power transmission amount of the power transmission unit;
a charging completion time prediction section, which calculates a predicted charging completion time of the battery based on the residual capacity of the battery recognized by the battery residual capacity recognition section and the power transmission amount of the power transmission unit detected by the power transmission amount detection section; and
a notification section, which notifies a user of an external terminal of the predicted charging completion time calculated by the charging completion time prediction section.

In the non-contact charging system, preferably,
the charging control device further includes
a scheduled use start time recognition section which recognizes a scheduled use start time of the vehicle used by the user, and
the notification section controls a notification form of the predicted charging completion time notified to the user of the external terminal by the notification section based on information related to the foreign matter detected by the foreign matter detection section, the predicted charging completion time calculated by the charging completion time prediction section, and the scheduled use start time of the vehicle recognized by the scheduled use start time recognition section.

In the non-contact charging system, preferably, information notified to the user by the notification section through the external terminal includes:
information for urging the removal of the foreign matter of which the existence and the type are detected by the foreign matter detection section,
the predicted charging completion time of the battery calculated by the charging completion time prediction section, and
the scheduled use start time of the vehicle recognized by the scheduled use start time recognition section; and
when the predicted charging completion time is earlier than the scheduled use start time of the vehicle, or when the predicted charging completion time is before a predetermined period elapses from the scheduled use start time of the vehicle, the charging control device omits the notification of the information for urging the removal of the foreign matter, which is notified by the notification section.

In the non-contact charging system, preferably,
the foreign matter detection section has:
a metal detector configured by a coil array which detects the existence of an object containing metal that is foreign matter existing above the power transmission unit, and a living body detector which detects the existence of a living body that is foreign matter existing around the power transmission unit; and
the charging control device controls the reduction amount of the power transmission amount according to each output signal of the metal detector and the living body detector.

### BRIEF DESCRIPTION OF THE DRAWINGS

FIG. 1 is an explanatory diagram related to a configuration of a non-contact charging system which is one embodiment of the disclosure.

FIG. 2 is an explanatory diagram related to a configuration of a foreign matter detection section.

FIG. 3 is an explanatory diagram related to a function of the non-contact charging system which is one embodiment of the disclosure.

### DESCRIPTION OF THE EMBODIMENTS

According to the non-contact charging system having the configuration, corresponding to a case in which the existence and the type of the foreign matter that obstructs the power transmission around the power transmission unit are detected when the battery mounted on the vehicle is charged by a non-contact method, the power transmission amount of the power transmission unit is reduced, and the reduction amount is controlled according to the difference in the type of the foreign matter. Therefore, even if the foreign matter exists which obstructs the power transmission around the power transmission unit, the power transmission amount can be reduced within an allowable range in view of the type of the foreign matter, and the power transmission of the power transmission unit can be continued without being stopped. Therefore, the required charging period of the battery mounted on the vehicle is shortened.

According to the non-contact charging system having the configuration, in view of the power transmission amount of the power transmission unit in which the reduction amount is adjusted according to the difference in the type of the foreign matter as described above, that is, the charging capability of the battery mounted on the vehicle, a predicted charging completion time having high precision is notified to the user, and thus the improvement of usability of the notification and the convenience of the non-contact charging system are achieved for the user.

According to the non-contact charging system having the configuration, the notification form is controlled based on the scheduled time when the user starts to use the vehicle, the residual capacity of the battery mounted on the vehicle, the power transmission amount of the power transmission unit, and the information related to the foreign matter. Therefore, the annoyance of the notification is reduced, and the convenience of the non-contact charging system is improved for the user.

According to the non-contact charging system having the configuration, the notification for urging the removal of the foreign matter is intentionally omitted when it is predicted that the charging of the battery mounted on the vehicle is completed before a use start time of the vehicle or before a predetermined period elapses from the use start time of the vehicle even if the power transmission amount of the power transmission unit is reduced. Therefore, the user is released from the annoyance of the notification, and the convenience of the non-contact charging system is improved.

According to the non-contact charging system having the configuration, when the object containing metal is detected as foreign matter, smoking and ignition caused by heat generation of the coil array which constitutes the metal detector can be prevented by the reduction during the power transmission of the power transmission unit. In addition, when the living body, especially a body part of the user is detected as foreign matter, by the reduction of the power transmission amount, a situation can be avoided in which the body part of the user is exposed to an electromagnetic wave leaked from the power transmission unit. Because the object containing metal and the living body which are the types of the foreign matter can be discriminated with high precision, the reduction amount of the power transmission amount corresponding to the types of the foreign matter is appropriately controlled.

(Configuration)

(Configuration of non-contact charging system)

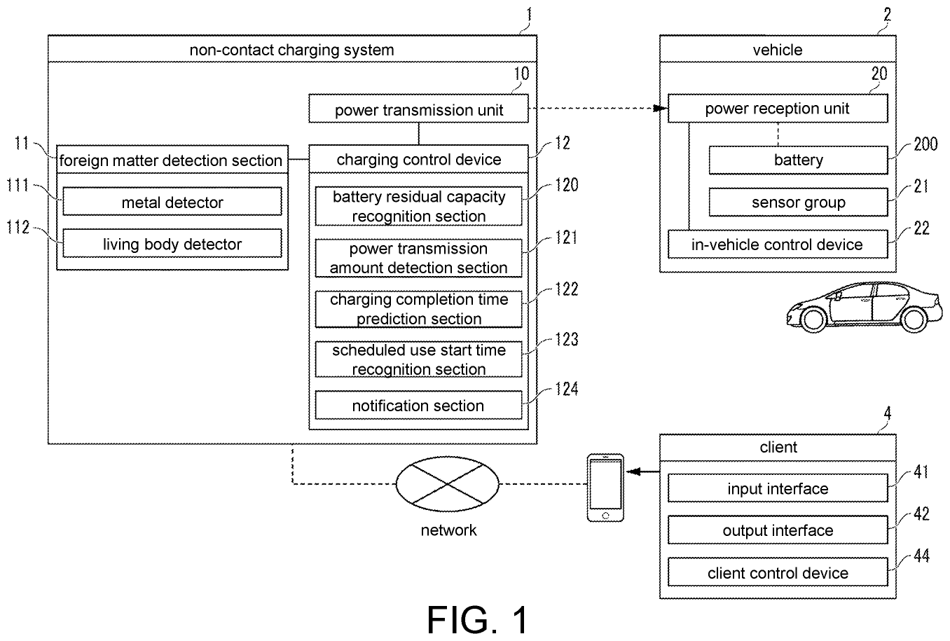

A non-contact charging system 1 which is one embodiment of the disclosure shown in FIG. 1 includes a power transmission unit 10, a foreign matter detection section 11, and a charging control device 12. The non-contact charging system 1 has an intercommunication function with each of a vehicle 2 and a client 4. A communication method between the non-contact charging system 1 and the vehicle 2 and a communication method between the non-contact charging system 1 and the client 4 may be the same or different.

The power transmission unit 10 transmits power to a power reception unit 20 mounted on the vehicle 2 by a non-contact method in order to charge a battery 200 mounted on the vehicle 2. For example, the power transmission unit 10 is set in a parking space of the vehicle 2.

The foreign matter detection section 11 includes a metal detector 111 and a living body detector 112 which are disposed around or in the vicinity of the power transmission unit 10.

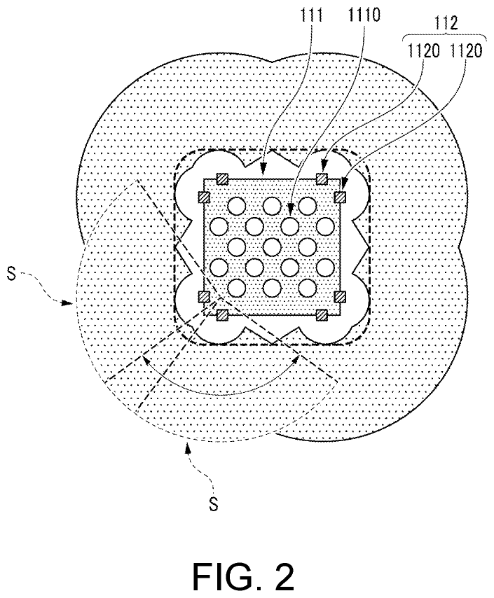

For example, as shown in FIG. 2, the metal detector 111 is configured by a coil array in which a plurality of coils 1110 are distributively disposed along a substantially flat surface and some or all of the coils 1110 are embedded in a resin-made pad which constitutes the power transmission unit 10. Based on a change form of a vibration waveform signal supplied to each of the plurality of coils 1110 from an oscillator, the metal detector 111 detects the presence/absence and the position of the metal above the power transmission unit 10.

For example, the living body detector 112 is configured by a plurality of ultrasonic wave sensors 1120. As shown in FIG. 2, the plurality of ultrasonic wave sensors 1120 are respectively disposed in different locations of a peripheral edge section of the resin-made pad which constitutes the power transmission unit 10. A detectable range S of the living body detector 112 shown in FIG. 2 has a three-dimensional shape in which a fan shape is rotated around an axis line passing through the living body detector 112. Based on an output signal of each of the plurality of ultrasonic wave sensors 1120, the living body detector 112 detects the presence/absence and the position of the living body around the power transmission unit 10.

Based on the existence and the type of the foreign matter detected by the foreign matter detection section 11, the charging control device 12 controls a power transmission operation of the power transmission unit 10. The charging control device 12 includes a battery residual capacity recognition section 120, a power transmission amount detection section 121, a charging completion time prediction section 122, a scheduled use start time recognition section 123, and a notification section 124.

Based on the communication with the vehicle 2, the battery residual capacity recognition section 120 recognizes the residual capacity or the SOC of the battery 200 corresponding to output signals of voltage sensors and the like which constitute a sensor group 21 mounted on the vehicle 2. The power transmission amount detection section 121 detects the power transmission amount of the power transmission unit 10. Based on the residual capacity of the battery 200 and the power transmission amount of the power transmission unit 10, the charging completion time prediction section 122 calculates the predicted charging completion time of the battery 200. Based on the communication with the vehicle 2, the client 4 and/or a server (not shown), the scheduled use start time recognition section 123 recognizes the scheduled use start time (for example, scheduled boarding time) of the vehicle 2 used by the user. The notification section 124 notifies the user of the predicted charging completion time through the client 4.

The charging control device 12, as well as the battery residual capacity recognition section 120, the power transmission amount detection section 121, the charging completion time prediction section 122, the scheduled use start time recognition section 123, and the notification section 124 which constitute the charging control device 12 is configured by a storage device (for example, a HDD, a memory, a SSD configured by the memory, or the like) and an algorithm processing device (for example, a CPU, a single-core processor, a multi-core processor, or the like) which reads out necessary data and programs (software) from the storage device and takes the data as the object to execute algorithm processing according to the programs.

(Configuration of Vehicle)

The vehicle 2 shown in FIG. 1 includes the power reception unit 20, the sensor group 21, an in-vehicle control device 22, and the battery 200.

The power reception unit 20 receives power from the power transmission unit 10 which is set in a specified location by a non-contact method in order to charge the battery 200. For example, the battery 200 is configured by a lithium-ion secondary battery. The in-vehicle control device 22 appropriately controls the operation of each constituent element of the vehicle 2 according to the output signals of various sensors which constitute the sensor group 21.

Similar to the charging control device 12, the in-vehicle control device 22 is configured by a storage device (for example, a HDD, a memory, a SSD configured by the memory, or the like) and an algorithm processing device (for example, a CPU, a single-core processor, a multi-core processor, or the like) which reads out necessary data and programs (software) from the storage device and takes the data as the object to execute algorithm processing according to the programs.

(Configuration of Client)

The client 4 is a terminal device such as a smartphone, a tablet terminal, or a personal computer, and includes an input interface 41, an output interface 42, and a client control device 44. The input interface 41 is configured by a touch panel type button, switch, and the like. The output interface 42 includes an image output device and a radio communication equipment. The client control device 44 is configured by an algorithm processing device (a single-core processor, a multi-core processor, or processor cores which constitute the multi-core processor), reads out necessary data and software from the storage device such as a memory, and takes the data as the object to execute algorithm processing according to the software.

(Function)

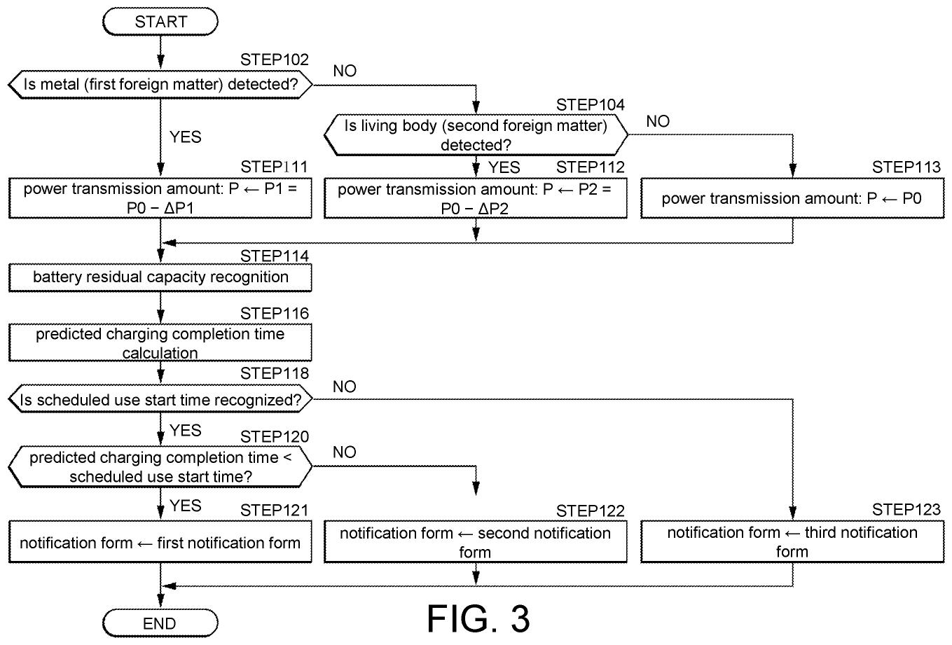

One embodiment of the function of the non-contact charging system 1 having the configuration is described using a flow chart in FIG. 3. After the vehicle 2 is parked in a position in which the power transmission from the power transmission unit 10 to the power reception unit 20 can be achieved in the parking space, and the communication between the non-contact charging system 1 and the vehicle 2 is established, the function is exhibited.

Firstly, it is determined that whether or not the existence of a metal or an object containing metal (first foreign matter) is detected above or in the vicinity of the power transmission unit 10 by the foreign matter detection section 11 through the metal detector 111 (FIG. 3/STEP 102). When the determination result is positive (FIG. 3/STEP 102 . . . YES), by the charging control device 12, a power transmission amount P of the power transmission unit 10 is controlled as a first power transmission amount P1 which is reduced from a normal power transmission amount PO by ΔP1 (FIG. 3/STEP 111). At this time, it is detected by the power transmission amount detection section 121 that the power transmission amount P of the power transmission unit 10 is the first power transmission amount P1. The first power transmission amount P1 is set low enough to prevent smoking and ignition caused by the heat generation of the coil array which constitutes the metal detector 111.

In contrast, when the determination result is negative (FIG. 3/STEP 102 . . . NO), it is determined that whether or not the existence of a living body (second foreign matter) such as a human limb or the like is detected around the power transmission unit 10 by the foreign matter detection section 11 through the living body detector 112 (FIG. 3/STEP 104). At this time, it may be determined that a distance between the ultrasonic wave sensors which constitute the living body detector 112 and the living body is equal to or smaller than a predetermined distance, and/or an approaching speed of the living body with respect to the ultrasonic wave sensors is equal to or higher than a predetermined speed.

When the determination result is positive (FIG. 3/STEP 104 . . . YES), by the charging control device 12, the power transmission amount P of the power transmission unit 10 is controlled as a second power transmission amount P2 which is reduced from the normal power transmission amount PO by ΔP2 (for example, ΔP2<ΔP1) (FIG. 3/STEP 112). At this time, it is detected by the power transmission amount detection section 121 that the power transmission amount P of the power transmission unit 10 is the second power transmission amount P2. The second power transmission amount P2 is set low enough to avoid a situation in which the living body is exposed to an electromagnetic wave leaked from the power transmission unit 10.

In contrast, when the determination result is negative (FIG. 3/STEP 104 . . . NO), by the charging control device 12, the power transmission amount P of the power transmission unit 10 is controlled as the normal power transmission amount P0 (FIG. 3/STEP 113). At this time, it is detected by the power transmission amount detection section 121 that the power transmission amount P of the power transmission unit 10 is the normal power transmission amount P0.

Furthermore, the battery residual capacity of the battery 200 of the vehicle 2 is recognized by the battery residual capacity recognition section 120 (FIG. 3/STEP 114). For example, the battery residual capacity may be measured by the in-vehicle control device 22 based on the output signals of the voltage sensors and the like which constitute the sensor group 21 of the vehicle 2, and the battery residual capacity recognition section 120 may acquire the measurement result based on the communication with the vehicle 2.

Based on the residual capacity of the battery 200 recognized by the battery residual capacity recognition section 120 and the power transmission amount P of the power transmission unit 10 detected by the power transmission amount detection section 121, the predicted charging completion time is calculated by the charging completion time prediction section 122 (FIG. 3/STEP 116). For example, according to each of the different power transmission amounts P, data representing the change form of the charging amount of the battery 200 is read out. In this piece of data, a coupling coefficient or charging efficiency between the power transmission unit 10 and the power reception unit 20 is reflected. Then, in view of the time change form of the charging amount of the battery 200 corresponding to the power transmission amount P of the power transmission unit 10 and represented by the data described above, a period required for the charging of the battery 200 is predicted according to the residual capacity, and then a time after the period from the current time is calculated as the predicted charging completion time. For example, compared with a case in which the power transmission amount P of the power transmission unit 10 is the normal power transmission amount P0, the predicted charging completion time of the battery 200 is later in time series in a case in which the power transmission amount P of the power transmission unit 10 is the first power transmission amount P1 or the second power transmission amount P2.

It is determined that whether or not the scheduled use start time of the vehicle 2 is recognized by the scheduled use start time recognition section 123 (FIG. 3/STEP 118). For example, based on the communication with the client 4, the scheduled use start time recognition section 123 recognizes an action plan or a schedule input by the user of the vehicle 2 through the input interface 41 of the client 4, and thereby recognizes the scheduled use start time of the vehicle 2 which is included in the action plan and the like.

When the determination result is negative (FIG. 3/STEP 118 . . . NO), based on the communication with the client 4 of the user of the vehicle 2, the notification form notified to the user through the client 4 is controlled as a third notification form by the notification section 124 (FIG. 3/STEP 123). Accordingly, the predicted charging completion time of the battery 200, for example, “The charging will be completed at ●●:●●.” is output to the output interface 42 by the client control device 44. In addition, when foreign matter is detected by the foreign matter detection section 11, a notification for urging the removal or evacuation of the foreign matter, for example, “Charging output is limited because a foreign matter is detected. If you want to complete the charging earlier, please check the vehicle and remove the foreign matter.” may be output in the output interface 42. Furthermore, a notification representing the type of the foreign matter, for example, whether the foreign matter is a metal or a living body may be output in the output interface 42.

In contrast, when the determination result is positive (FIG. 3/STEP 118 . . . YES), it is further determined that whether or not the predicted charging completion time of the battery 200 is earlier than the scheduled use start time, or whether or not the predicted charging completion time of the battery 200 is before a predetermined period elapses from the scheduled use start time (FIG. 3/STEP 120).

When the determination result is positive (FIG. 3/STEP 120 . . . YES), based on the communication with the client 4 of the user of the vehicle 2, the notification form notified to the user through the client 4 is controlled as a first notification form by the notification section 124 (FIG. 3/STEP 121). Accordingly, for example, different from the third notification form described above, no notification for urging the removal or evacuation of the foreign matter is output in the output interface 42. At this time, a notification of the predicted charging completion time of the battery 200 earlier than the scheduled use start time of the vehicle 2 (or before a predetermined period elapses from the scheduled use start time of the vehicle 2), for example, “The charging will be completed at ●●:●● earlier than the scheduled use start time of the vehicle ∘∘:∘∘.” may be output in the output interface 42, or the output may be omitted.

In contrast, when the determination result is negative (FIG. 3/STEP 120 . . . NO), based on the communication with the client 4 of the user of the vehicle 2, the notification form notified to the user through the client 4 is controlled as a second notification form by the notification section 124 (FIG. 3/STEP 122). Accordingly, for example, similar to the third notification form described above, the notification for urging the removal or evacuation of the foreign matter is output in the output interface 42. At this time, a notification of the predicted charging completion time of the battery 200 later than the scheduled use start time of the vehicle 2 (or after a predetermined period elapses from the scheduled use start time of the vehicle 2), for example, “The charging will be completed at ●●:●● later than the scheduled use start time of the vehicle ∘∘:∘∘.” may be output in the output interface 42.

(Effect)

According to the non-contact charging system having the configuration, corresponding to a case in which the existence and the type of the foreign matter that obstructs the power transmission around the power transmission unit 10 are detected when the battery 200 mounted on the vehicle 2 is charged by a non-contact method, the power transmission amount P of the power transmission unit 10 is reduced, and the reduction amount is controlled according to a difference in the type of the foreign matter (see FIG. 3/STEP 102 . . . YES→STEP 111 and STEP 104 . . . YES→STEP 112). Therefore, even if the foreign matter exists which obstructs the power transmission around the power transmission unit 10, the power transmission amount can be reduced within an allowable range in view of the type of the foreign matter, and the power transmission of the power transmission unit 10 can be continued without being stopped. Therefore, the required charging period of the battery 200 mounted on the vehicle 2 is shortened.

In addition, in view of the power transmission amount P of the power transmission unit 10 in which the reduction amount is adjusted according to the difference in the type of the foreign matter, that is, the charging capability of the battery 200 mounted on the vehicle 2, a predicted charging completion time having high precision is notified to the user, and thus the improvement of usability of the notification and the convenience of the non-contact charging system 1 are achieved for the user (see FIG. 3/STEPS 111, 112, and 123→STEP 114→STEP 116→. . . →STEPS 121, 122, and 123).

Furthermore, a notification for urging the removal of the foreign matter is intentionally omitted when it is predicted that the charging of the battery 200 mounted on the vehicle 2 is completed before a use start time of the vehicle 2 or before a predetermined period elapses from the use start time of the vehicle 2 even if the power transmission amount P of the power transmission unit 10 is reduced (see FIG. 3/STEP 120 . . . YES→STEP 121). Therefore, the user is released from the annoyance of the notification, and the convenience of the non-contact charging system 1 is improved.

What is claimed is:

1. A non-contact charging system, comprising: a power transmission unit, which transmits power to a power reception unit mounted on a vehicle by a non-contact method in order to charge a battery mounted on the vehicle;
a charging control device, which controls a power transmission amount of the power transmission unit; and
a foreign matter detection section, which is used for detecting the existence and the type of foreign matter that exists around the power transmission unit; wherein based on a requirement that the existence and the type of the foreign matter are detected by the foreign matter detection section when the power is transmitted to the power reception unit by the power transmission unit, the charging control device reduces the power transmission amount of the power transmission unit, and changes the reduction amount of the power transmission amount of the power transmission unit according to a difference in the type of the foreign matter.

2. The non-contact charging system according to claim 1, wherein
the charging control device comprises:
a battery residual capacity recognition section, which recognizes a residual capacity of the battery;
a power transmission amount detection section, which detects a power transmission amount of the power transmission unit;
a charging completion time prediction section, which calculates a predicted charging completion time of the battery based on the residual capacity of the battery recognized by the battery residual capacity recognition section and the power transmission amount of the power transmission unit detected by the power transmission amount detection section; and
a notification section, which notifies a user of an external terminal the predicted charging completion time calculated by the charging completion time prediction section.

3. The non-contact charging system according to claim 2, wherein
the charging control device further comprises
a scheduled use start time recognition section which recognizes a scheduled use start time of the vehicle used by the user, and
the notification section controls a notification form of the predicted charging completion time notified to the user of the external terminal by the notification section based on information related to the foreign matter detected by the foreign matter detection section, the predicted charging completion time calculated by the charging completion time prediction section, and the scheduled use start time of the vehicle recognized by the scheduled use start time recognition section.

4. The non-contact charging system according to claim 3, wherein
information notified to the user by the notification section through the external terminal comprises:
information for urging the removal of the foreign matter of which the existence and the type are detected by the foreign matter detection section,
the predicted charging completion time of the battery calculated by the charging completion time prediction section, and
the scheduled use start time of the vehicle recognized by the scheduled use start time recognition section; and
when the predicted charging completion time is earlier than the scheduled use start time of the vehicle, or when the predicted charging completion time is before a predetermined period elapses from the scheduled use start time of the vehicle, the charging control device omits the notification of the information for urging the removal of the foreign matter, which is notified by the notification section.

5. The non-contact charging system according to any one of claim 1, wherein
the foreign matter detection section has:
a metal detector configured by a coil array which detects the existence of an object containing metal that is foreign matter existing above the power transmission unit, and
a living body detector which detects the existence of a living body that is foreign matter existing around the power transmission unit; and
the charging control device controls the reduction amount of the power transmission amount according to each output signal of the metal detector and the living body detector.

6. The non-contact charging system according to any one of claim 2, wherein
the foreign matter detection section has:
a metal detector configured by a coil array which detects the existence of an object containing metal that is foreign matter existing above the power transmission unit, and
a living body detector which detects the existence of a living body that is foreign matter existing around the power transmission unit; and
the charging control device controls the reduction amount of the power transmission amount according to each output signal of the metal detector and the living body detector.

7. The non-contact charging system according to any one of claim 3, wherein
the foreign matter detection section has:
a metal detector configured by a coil array which detects the existence of an object containing metal that is foreign matter existing above the power transmission unit, and
a living body detector which detects the existence of a living body that is foreign matter existing around the power transmission unit; and
the charging control device controls the reduction amount of the power transmission amount according to each output signal of the metal detector and the living body detector.

8. The non-contact charging system according to any one of claim 4, wherein
the foreign matter detection section has:
a metal detector configured by a coil array which detects the existence of an object containing metal that is foreign matter existing above the power transmission unit, and
a living body detector which detects the existence of a living body that is foreign matter existing around the power transmission unit; and
the charging control device controls the reduction amount of the power transmission amount according to each output signal of the metal detector and the living body detector.
